(19) United States
(12) Patent Application Publication
(10) Pub. No.: US 2013/0130031 A1
(43) Pub. Date: May 23, 2013

(54) INSULATED WIRE

(71) Applicant: HITACHI CABLE, LTD., Tokyo (JP)

(72) Inventors: Takanori YAMAZAKI, Mito-shi (JP); Hideto MOMOSE, Hitachiota-shi (JP); Shigehiro MORISHITA, Hitachi-shi (JP)

(73) Assignee: HITACHI CABLE, LTD., Tokyo (JP)

(21) Appl. No.: 13/678,781

(22) Filed: Nov. 16, 2012

(30) Foreign Application Priority Data
Nov. 18, 2011 (JP) 2011-252278

(51) Int. Cl. H01B 3/42; H01B 7/02

(52) U.S. Cl. CPC H01B 3/427; H01B 7/0275
USPC 428/375

(57) ABSTRACT

There is provided an insulated wire including a wire conductor and at least one extruded insulation layer formed on the wire conductor. The at least one extruded insulation layer is made of a phase separated resin composition including: a resin (A) including polyether ether ketone as a continuous phase; and a resin (B) with a relative dielectric constant of 2.6 or less as a dispersed phase.

### CLAIM OF PRIORITY

The present application claims priority from Japanese patent application serial no. 2011-252278 filed on Nov. 18, 2011, the content of which is hereby incorporated by reference into this application.

### BACKGROUND OF THE INVENTION

1. Field of the Invention

The present invention relates to insulated wires used for coils in electrical equipment such as rotary electric machines and transformers. More particularly, the invention relates to insulated wires covered with at least an extrusion coated insulation layer.

2. Description of Related Art

Insulated or enameled wires are used for coils in electrical equipment such as rotary electric machines and transformers. Such insulated wires are typically formed by applying one or more insulation coatings around a metal conductor having a desired cross section (such as circular and rectangular) depending on the shape and application of the coil. Typically, insulation coatings are formed by the following two methods: One method is to apply, on a wire conductor, an insulation varnish prepared by dissolving a resin in an organic solvent and baking the applied varnish. The other method is to extrusion coat a preblended resin composition on a wire conductor.

Because of the recent demand for compact electrical equipment, insulated wires are wound around a smaller diameter core with a finer pitch under a higher tension in current coil winding processes. Insulation coatings for such insulated wires require sufficient mechanical properties (such as adhesiveness and wear resistance) to withstand severe mechanical stresses caused by such harsh coil winding processes.

Also, because of the recent demand for high efficiency and high output power electrical equipment, there has been an increasing use of inverters and high voltages. As a result, coils are subjected to higher operating temperatures. Hence, insulation coatings also require high thermal resistance. In addition, high voltages (such as surge voltages from an inverter) applied to a coil may generate partial discharges, thus potentially degrading or damaging the insulation coating.

In order to prevent degradation or damage of insulation coatings by partial discharge, insulation coatings having a higher partial discharge inception voltage are being actively developed. One exemplary method for increasing the partial discharge inception voltage of an insulation coating is to use a low dielectric constant resin for the insulation coating.

For example, JP-A 2002-056720 discloses an insulation coating material containing a fluorine-containing polyimide resin having a special structure. The relative dielectric constant of the insulation coating material of this disclosure is 2.3 to 2.8, which is significantly lower than those of conventional insulation varnishes (about 3 to 4). According to this disclosure, heat generation in the insulation coating can be suppressed because of the low dielectric constant of the coating material.

JP-A 2005-106898 discloses an insulated wire formed by extruding two or more insulation layers on a wire conductor. At least one of the insulation layers other than the innermost layer is made from a resin mixture including 100 parts by mass of a polyphenylene sulfide resin as a continuous phase and 3 to 40 parts by mass of an olefin-based copolymer as a dispersed phase. According to this disclosure, the insulated wire has excellent thermal and chemical resistance.

The above-cited technologies have the following problems or disadvantages: The above JP-A 2002-56720 technology can reduce the dielectric constant of an insulation coating by making the coating using the disclosed fluorine-containing polyimide resin. However, generally, insulation coatings made of a fluorine-containing polyimide resin have poor adhesion to wire conductors. Thus, an insulation coating made of the fluorine-containing polyimide resin of the JP-A 2002-56720 may be lifted off from a wire conductor by severe mechanical stresses caused by harsh processes such as winding, which leads to a degradation of the partial discharge inception voltage of the insulated wire.

In the JP-A 2005-106898 insulated wire, more than half of the extruded insulation layer other than the innermost layer is made of polyphenylene sulfide resin whose melting point is approximately 280° C. Therefore, when the temperature of the insulated wire exceeds about 300° C. even locally, the extruded insulation layer containing the polyphenylene sulfide resin may be significantly deformed and may not maintain its electrical insulation properties. Thus, the insulated wire of this disclosure may have a problem of poor thermal resistance.

As described above, currently, electrical equipment tends to be operated at higher temperatures than ever before. Also, coil wires tend to be wound more densely to obtain higher filling factors, and, as a result, insulated wires are prone to be overheated locally during electrical equipment operation. When the temperature of insulated wires rises even locally, decreases the partial discharge inception voltage of the overheated local portions of the wire, thus degrading the electrical insulation properties of the wire. Hence, a strong demand exists to further improve the thermal resistance of insulated wires in order to prevent degradation of the electrical insulation properties even at higher use temperatures.

### SUMMARY OF THE INVENTION

In order to solve the above problems, it is an objective of the present invention to provide an insulated wire having excellent thermal resistance and a high partial discharge inception voltage.

According to one aspect of the present invention, there is provided an insulated wire including:

a wire conductor; and

at least one extruded insulation layer formed on the wire conductor, the at least one extruded insulation layer being made of a phase separated resin composition including:

a resin (A) including polyether ether ketone as a continuous phase; and

a resin (B) with a relative dielectric constant of 2.6 or less as a dispersed phase.

In the above aspect of the present invention, the following modifications and changes can be made.

(i) Parts by mass ratio of the resin (A) to the resin (B) “(A)/(B)” is from 25/70 to 60/35.

(ii) The resin (A) is polyether ether ketone or a mixture of polyether ether ketone and polyphenylene sulfide, and the resin (B) is polyethylene, polypropylene, 4-methylpentene-1, syndiotactic polystyrene or a mixture of two or more thereof.

(iii) The resin (A) has an apparent viscosity at 380° C. less than the apparent viscosity at 380° C. of the resin (B).

(iv) The apparent viscosity of the resin (A) at 380° C. is 2000 Pa·s or less.

(v) At least one additional coating layer made of one of thermoplastic polyamide-imide, thermoplastic polyimide, polyetherimide and polyphenylene sulfide is further formed on the at least one extruded insulation layer.

### Advantages of the Invention

According to the present invention, it is possible to provide an insulated wire having excellent thermal resistance and a high partial discharge inception voltage.

### BRIEF DESCRIPTION OF THE DRAWINGS

FIG. 1 is a schematic illustration showing a cross-sectional view of a first embodiment of the insulated wire of the present invention.

FIG. 2 is a schematic illustration showing a cross-sectional view of a second embodiment of the insulated wire of the present invention.

FIG. 3 is a schematic illustration showing a cross-sectional view of a third embodiment of the insulated wire of the present invention.

### DETAILED DESCRIPTION OF THE PREFERRED EMBODIMENTS

The present inventors have intensively investigated the composition and structure of various resin compositions to be used for insulation coatings extruded on wire conductors, in order to obtain an insulated wire having good partial discharge resistance even at high use temperatures (e.g. 200° C. or higher). This investigation has shown that phase separated resin compositions including a resin (A) containing polyether ether ketone as a continuous phase and a resin (B) with a relative dielectric constant of 2.6 or less as a dispersed phase improves the partial discharge resistance of the resulting insulated wire. Specifically, extrusion coatings made of the above-specified phase separated resin composition have a high partial discharge inception voltage Vp of 1300 V or higher at room temperature and also has satisfactorily good partial discharge resistance even at high use temperatures. The present invention is based on this new finding.

Preferred embodiments of the present invention will be described below. However, the present invention is not limited to the specific embodiments described below, but various combinations and modifications are possible without departing from the spirit and scope of the invention.

As described above, the invented extrusion coated layer for insulated wires is made of a phase separated resin composition. The phase separated resin composition includes a resin (A) containing polyether ether ketone as a continuous phase and a resin (B) with a relative dielectric constant of 2.6 or less as a dispersed phase. The invented combination of the resins (A) and (B) shows practically no increase in the relative dielectric constant of the resulting insulation coating even at high use temperatures, and therefore has the effect of increasing the partial discharge inception voltage of the resulting insulated wire in the range from room temperature to high use temperatures.

As the resin (A) serving as the continuous phase, polyether ether ketone (PEEK) may be used alone or in mixture with polyphenylene sulfide (PPS). The PPS content is preferably equal to or greater than the PEEK content. Using this mixing ratio, the advantageous effect of the present invention is achieved more stably.

As the resin (B) serving as the dispersed phase, preferably, polyethylene, polypropylene, 4-methylpentene-1 and syndiotactic polystyrene can be advantageously used alone or in combination. Examples of polyethylenes having a relative dielectric constant of 2.6 or less include low-density polyethylene, linear low-density polyethylene, medium-density polyethylene, high-density polyethylene and ultrahigh molecular weight polyethylene. Examples of polypropylenes having a relative dielectric constant of 2.6 or less include isotactic polypropylene, syndiotactic polypropylene, homopolypropylene and copolymers of polypropylene and ethylene-propylene. These resins may be used in combination with 4-methylpentene-1 (with a relative dielectric constant of 2.6 or less) or syndiotactic polystyrene (with a relative dielectric constant of 2.6 or less). Addition of ultrahigh molecular weight polyethylene is effective in adjusting (e.g. increasing) the viscosity of the resin (B).

The parts by mass ratio of the resin (A) to the resin (B) (hereinafter, (A)/(B) ratio) is preferably from 25/70 to 60/35, and more preferably from 25/70 to 50/45. (A)/(B) ratios less than 25/70 cannot provide required thermal resistance. (A)/(B) ratios more than 60/35 reduce the effect of lowering the relative dielectric constant of the resulting phase separated resin, and therefore cannot provide a required high partial discharge inception voltage. Mixing the resins (A) and (B) in the parts by mass ratio specified above can increase the partial discharge inception voltage of the resulting insulated wire both at room temperatures and at high use temperatures. Advantageously, an insulation coating having such a higher partial discharge inception voltage per unit thickness can be formed thinner while maintaining the same partial discharge resistance.

In order to enhance the stability of the phase separated structure made of the mixture of the resins (A) and (B), to the above-described resin composition may be added and mixed an ethylene copolymer (such as copolymers of ethylene and vinyl acetate, copolymers of ethylene and ethyl acrylate, copolymers of ethylene and methyl acrylate and copolymers of ethylene and glycidyl methacrylate) or polyethylene, polypropylene, etc. (as cited above) modified with maleic anhydride or glycidyl methacrylate, as a resin additive.

As described, the extrusion coated layer of the insulated wire of the present invention has the phase separated structure including the continuous phase resin (A) and the dispersed phase resin (B). This invented phase separated structure achieves both good thermal resistance and a high partial discharge inception voltage. In order to obtain the invented phase separated structure, the apparent viscosity of the molten resin (A) during extrusion process is preferably less than that of the resin (B). Specifically, the apparent viscosity of the resin (A) at 380° C. is preferably 2000 Pa·s or less.

Furthermore, the average molecular weight of the resin (A) is preferably less than that of the resin (B). This allows the apparent viscosities of the resins (A) and (B) to be easily adjusted to satisfy the above-described preferable viscosity relationship.

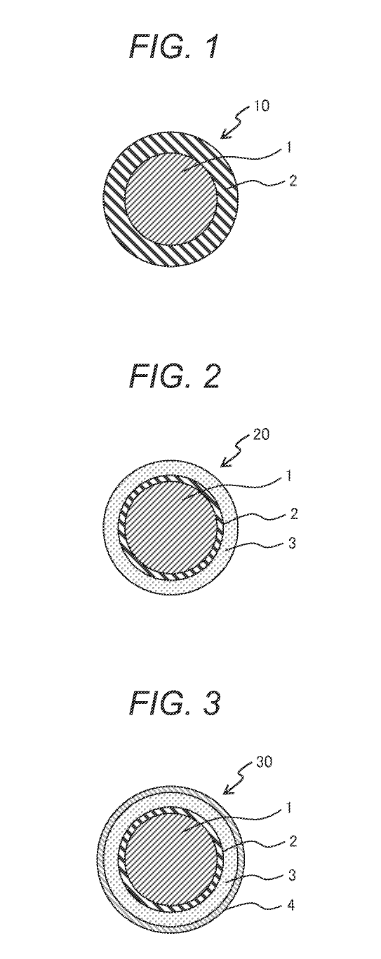

FIG. 1 is a schematic illustration showing a cross-sectional view of a first embodiment of the insulated wire of the present invention. As illustrated in FIG. 1, the invented insulated wire 10 of the first embodiment includes a first extrusion coated layer 2 formed directly on a wire conductor 1. The first extrusion coated layer 2 has a phase separated structure including a continuous phase resin (A) and a dispersed phase resin (B). The continuous phase resin (A) is made of PEEK or a mixture of PEEK and PPS. The dispersed phase resin (B) is made of one or more materials with a relative dielectric constant of 2.6 or less selected from polyethylene, polypropylene, 4-methylpentene-1 and syndiotactic polystyrene.

FIG. 2 is a schematic illustration showing a cross-sectional view of a second embodiment of the insulated wire of the present invention. The invented insulated wire 20 of the second embodiment further includes a second extrusion coated layer 3 extruded on the first extrusion coated layer 2. The second extrusion coated layer 3 is made of one of thermoplastic polyamide-imide, thermoplastic polyimide, polyetherimide, and polyphenylene sulfide.

There is no particular limitation on the method for extruding the second extrusion coated layer 3, but, preferably, the second layer 3 is extruded so as to contact (bond with) the first layer 2 at an elevated temperature. This high temperature bonding increases the adhesion between the two coating layers and therefore increases the mechanical strength of the resulting wire. The first and second layers 2 and 3 may be co-extruded. Or, the second layer 3 may be extruded immediately after the extrusion of the first layer 2 in the same extruder (what is called “tandem extrusion”). These methods simplify the wire insulation process which leads to low manufacture cost.

FIG. 3 is a schematic illustration showing a cross-sectional view of a third embodiment of the insulated wire of the present invention. The invented insulated wire 30 of the third embodiment still further includes a third extrusion coated layer 4 extruded on the second extrusion coated layer 3. The third extrusion coated layer 4 is made of one of thermoplastic polyamide-imide, thermoplastic polyimide, polyetherimide, and polyphenylene sulfide. This multi-layer coating structure increases the adhesion between the conductor 1 and the first layer 2 as well as the adhesion between the first and second layers 2 and 3, and also increases the thermal resistance of the entire insulation coating. In order to further increase the inter-layer adhesions, an adhesion-enhancing additive resin (such as ethylene/glycidyl methacrylate copolymer resins and polyamide 46) may be added to one or more of the above-described resins used to form the first, second and third layers 2,3 and 4.

The multi-layer coating structure also increases the abrasion resistance of the resulting wire. Such increase in abrasion resistance is effective in preventing coating defects (such as crack, crazing, wrinkle and lifting) even under strong external force (such as tensile force) exerted during, for example, coil winding process.

Similarly to the above embodiment, there is no particular limitation on the method for extruding the third extrusion coated layer 4, but, preferably, the third extrusion coated layer 4 is extruded so as to contact (bond with) the second layer 3 at an elevated temperature. Such high temperature bondings between the second and third layers as well as between the first and second layers increase the respective inter-layer adhesions and therefore ensure the mechanical strength of the resulting wire. By co-extruding or tandem-extruding all of the first, second and third layers 2, 3 and 4, the wire insulation process can be simplified.

A thickness of each of the first, second and third layers 2, 3 and 4 is preferably 20 μm or more. The total thickness of the three coating layers is preferably from 50 to 100 μm. As needed, an antioxidant, copper inhibitor, lubricant, colorant, etc. may be added to one or more of the above-described resins used to form the three coating layers. There is no particular limitation on the material of the wire conductor 1. Conductor materials typically used for insulated wires (e.g., oxygen-free copper and low oxygen content copper) can be used. The cross section of the wire conductor 1 is not limited to the circular one as shown in FIGS. 1 to 3, but may be rectangular.

### EXAMPLES

The present invention will be described in more detail below with reference to examples. However, the invention is not limited to the specific examples described below.

### Preparation of Examples 1 to 9 and Comparative Examples 1 to 3

Each of resin compositions of Examples and Comparative examples shown in Table 1 was extrusion-coated around a 1.25 mm diameter copper conductor using an extruder to form an insulated wire as shown in FIG. 1. The extrusion temperature was approximately 360° C., and the thickness of the insulation layer (the first extrusion coated layer) was approximately 100 μm. Table 1 shows contents of the resin composition used to form the extrusion coated layer of Examples 1 to 9 and Comparative examples 1 to 3. The apparent viscosity of the resins (A) in Table 1 was measured at a shear rate of 10 sec⁻¹ at 380° C. using a capillary rheometer (CAPIROGRAPH 1B available from TOYO SEIKI Co., Ltd.).

TABLE 1
Contents of Resin Composition for Extrusion Coated Layer
of Examples 1 to 9 and Comparative Examples 1 to 3.

| | | | Example | | | | | |
|---|---|---|---|---|---|---|---|---|
| Resin composition | | | 1 | 2 | 3 | 4 | 5 | 6 |
| Contents | Resin | Polyether ether ketone | 25 | 50 | — | — | — | — |
| (Parts | (A) | (Apparent viscosity = 2000 Pa · s) | | | | | | |
| by mass) | | Polyether ether ketone | — | — | 25 | 20 | 20 | 10 |
| | | (Apparent viscosity = 1000 Pa · s) | | | | | | |
| | | Polyether ether ketone | — | — | — | — | — | — |
| | | (Apparent viscosity = 4000 Pa · s) | | | | | | |
| | | Polyphenylene sulfide | — | — | — | 20 | 30 | 30 |
| | | (Apparent viscosity = 500 Pa · s) | | | | | | |
| | Resin | High-density polyethylene | 50 | 45 | 60 | 55 | 45 | 40 |
| | (B) | (Relative dielectric constant = 2.3, | | | | | | |
| | | Apparent viscosity = 1000 Pa · s) | | | | | | |
| | | High-density polyethylene | — | — | — | — | — | — |
| | | (Relative dielectric constant = 2.3, | | | | | | |
| | | Apparent viscosity = 500 Pa · s) | | | | | | |
| | | Syndiotactic polystyrene | — | — | — | — | — | 10 |
| | | (Relative dielectric constant = 2.6, | | | | | | |
| | | Apparent viscosity = 200 Pa · s) | | | | | | |
| | | Ultrahigh molecular weight | 20 | 5 | 10 | 5 | — | — |
| | | polyethylene | | | | | | |
| | | (Relative dielectric constant = 2.3, | | | | | | |
| | | Apparent viscosity ≧ 5000 Pa · s) | | | | | | |
| | Resin | Maleic anhydride modified | — | — | 5 | — | — | — |
| | additive | polyethylene | | | | | | |
| | | Ethylene/Glycidyl methacrylate | 5 | 5 | — | 5 | 5 | 10 |
| | | copolymer | | | | | | |

| | | | | | | Comparative | | |
|---|---|---|---|---|---|---|---|---|
| | | | Example | | | example | | |
| Resin composition | | | 7 | 8 | 9 | 1 | 2 | 3 |
| Contents | Resin | Polyether ether ketone | 60 | — | — | — | 100 | — |
| (Parts | (A) | (Apparent viscosity = 2000 Pa · s) | | | | | | |
| by mass) | | Polyether ether ketone | — | — | — | — | — | — |
| | | (Apparent viscosity = 1000 Pa · s) | | | | | | |
| | | Polyether ether ketone | — | 60 | 30 | 30 | — | — |
| | | (Apparent viscosity = 4000 Pa · s) | | | | | | |
| | | Polyphenylene sulfide | — | — | 30 | 30 | — | 100 |
| | | (Apparent viscosity = 500 Pa · s) | | | | | | |
| | Resin | High-density polyethylene | 35 | 30 | 35 | — | — | — |
| | (B) | (Relative dielectric constant = 2.3, | | | | | | |
| | | Apparent viscosity = 1000 Pa · s) | | | | | | |
| | | High-density polyethylene | — | — | — | 35 | — | — |
| | | (Relative dielectric constant = 2.3, | | | | | | |
| | | Apparent viscosity = 500 Pa · s) | | | | | | |
| | | Syndiotactic polystyrene | — | 10 | — | — | — | — |
| | | (Relative dielectric constant = 2.6, | | | | | | |
| | | Apparent viscosity = 200 Pa · s) | | | | | | |
| | | Ultrahigh molecular weight | — | — | — | — | — | — |
| | | polyethylene | | | | | | |
| | | (Relative dielectric constant = 2.3, | | | | | | |
| | | Apparent viscosity ≧ 5000 Pa · s) | | | | | | |
| | Resin | Maleic anhydride modified | — | — | — | — | — | — |
| | additive | polyethylene | | | | | | |
| | | Ethylene/Glycidyl methacrylate | 5 | 5 | 5 | 5 | — | — |
| | | copolymer | | | | | | |

The insulated wire specimens (Examples 1 to 9 and Comparative examples 1 to 3) were subjected to the following measurements and tests.

(1) Observation of Phase Separated Structure of Resin Composition

The phase separated structure of the first extrusion coated layer of each insulated wire specimen was observed using a transmission electron microscope (H-7650 available from Hitachi, Ltd.) or a scanning electron microscope (S-3500N available from Hitachi, Ltd.). Based on this observation, whether the phase of the resin (A) was the continuous or dispersed phase was determined.

(2) Partial Discharge Inception Voltage Measurement

The partial discharge inception voltage of each insulated wire specimen was measured as follows: Two 500-mm long wire pieces were cut from each insulated wire specimen. The two cut wire pieces were twisted around each other under a tension of 39 N (4 kgf) in a manner to have six twists along a length of 120 mm at a middle portion of the wire piece pair. An end portion (10 mm long) of the insulation coating of both wire pieces was peeled off using a wire stripper ABISOFIX. Next, the twisted wire pair was dried in a thermostat at 120° C. for 30 min and placed in a desiccator for 18 hours until room temperature was reached.

Then, the partial discharge inception voltage of the twisted wire pair was measured using a partial discharge automatic test system (DAC-6024 available from Soken Electric Co., Ltd.) The measurement was conducted at 25° C. and 50% relative humidity. A 50-Hz voltage was applied to the twisted wire pair to charge it, and the voltage was increased at a rate of 10 to 30 V/s. The partial discharge inception voltage Vp of the twisted wire pair was defined as the voltage at which a discharge of 50 pC began to occur 50 times or more. An insulated wire specimen having a partial discharge inception voltage of 1300 V or more was rated as “Passed”.

(3) Adhesion Test

Each insulated wire specimen was subjected to a sudden tensile test described in JIS C 3003. The adhesion of the insulated wire specimen was evaluated by the peel length. The peel length was defined as the length (as measured from the region of fracture) of the insulation coating that had been peeled or lifted off from the wire conductor by the sudden tensile test. An insulated wire specimen having a peel length of 2 mm or shorter was rated as “Excellent”; a specimen having a peel length of more than 2 mm and 20 mm or shorter was rated as “Passed”; and a specimen having a peel length of more than 20 mm was rated as “Failed”.

(4) Thermal Resistance Test (Evaluation of Partial Discharge Resistance at High Temperature)

The thermal resistance of each insulated wire specimen was tested as follows: Similarly to the above-described partial discharge inception voltage measurement, two 500 mm long wire pieces were cut from each insulated wire specimen. The two cut wire pieces were twisted around each other under a tension of 39 N (4 kgf) in such a manner to have six twists along a length of 120 mm at a middle portion of the wire piece pair. Next, the twisted wire pair was aged in an aging tester (a gear oven STD60P available from Toyo Seiki Kogyo Co., Ltd.) at 300° C. for 10 min. Then, the thus aged twisted wire pair was measured for the partial discharge inception voltage in the same manner as described above, and degradation percentage of the partial discharge inception voltage was calculated. An insulated wire specimen having a degradation percentage of less than 20% was rated as “Passed”, and an insulated wire specimen having a degradation percentage of 20% or more was rated as

“Failed”.

Table 2 shows the measurement and evaluation results (coating thickness, phase separated structure, partial discharge inception voltage, adhesion, and thermal resistance) of the insulated wires of Examples 1 to 9 and Comparative examples 1 to 3.

TABLE 2
Measurement and Evaluation Results of Examples 1 to 9 and Comparative Examples 1 to 3.

| | Example | | | | | |
|---|---|---|---|---|---|---|
| | 1 | 2 | 3 | 4 | 5 | 6 |
| Coating thickness | 100 | 100 | 100 | 100 | 100 | 100 |
| (μm) | | | | | | |
| Phase separated | Continuous | Continuous | Continuous | Continuous | Continuous | Continuous |
| structure of | phase | phase | phase | phase | phase | phase |
| resin A | | | | | | |
| Partial discharge | 1580 | 1570 | 1550 | 1570 | 1550 | 1520 |
| inception voltage | | | | | | |
| (V) | | | | | | |
| Adhesion | Passed | Passed | Passed | Excellent | Excellent | Excellent |
| Thermal resistance | Passed | Passed | Passed | Passed | Passed | Passed |

| | Example | | | Comparative example | | |
|---|---|---|---|---|---|---|
| | 7 | 8 | 9 | 1 | 2 | 3 |
| Coating thickness | 100 | 100 | 100 | 100 | 100 | 100 |
| (μm) | | | | | | |
| Phase separated | Continuous | Continuous | Continuous | Dispersed | Single | Single |
| structure of | phase | phase | phase | phase | phase | phase |
| resin A | | | | | | |
| Partial discharge | 1420 | 1390 | 1350 | 1270 | 1280 | 1250 |
| inception voltage | | | | | | |
| (V) | | | | | | |
| Adhesion | Passed | Passed | Excellent | Passed | Failed | Failed |
| Thermal resistance | Passed | Passed | Passed | Failed | Passed | Failed |

As can be seen from TABLE 2, the extrusion coated layer of the invented insulated wires of Examples 1 to 9 had a phase separated structure including a resin (A) as a continuous phase and a resin (B) as a dispersed phase, and had a sufficiently high partial discharge inception voltage Vp of 1300 V or higher even at a relatively thin coating thickness of 100 μm. Also, the invented insulated wires of Examples 1 to 9 had good adhesion and good thermal resistance.

Further comparison of Examples 1 to 9 reveals that Examples 1 to 7 having an apparent viscosity of 2000 Pa·s or less had a higher partial discharge inception voltage Vp 1400 V) compared with Examples 8 and 9 having an apparent viscosity of more than 2000 Pa·s. Also, Examples 1 to 6 having an (A)/(B) ratio from 25/70 to 50/45 had a still higher partial discharge inception voltage Vp (≧1500 V) than Example 7 whose (A)/(B) ratio was out of this range.

On the other hand, in Comparative example 1, the apparent viscosity of the resin (A) was higher than that of the resin (B) (which did not satisfy the condition specified by the present invention), and, as a result, the resin (B) became a continuous phase and the resin (A) became a dispersed phase. Consequently, Comparative example 1 had an insufficient partial discharge inception voltage Vp (<1300 V) and poor thermal resistance. Comparative example 2 used no resin (B) and therefore had no phase separated structure, and, as a result, had an insufficient partial discharge inception voltage and poor adhesion. Comparative example 3 used a resin (A) containing no PEEK and contained no resin (B), and, as a result, had a low partial discharge inception voltage, poor adhesion and poor thermal resistance.

All of the above results demonstrate that the invented insulated wires of Example 1 to 9 have excellent thermal resistance, excellent adhesion and a high partial discharge inception voltage.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. An insulated wire comprising:
a wire conductor; and
at least one extruded insulation layer formed on the wire conductor, the at least one extruded insulation layer being made of a phase separated resin composition including:
a resin (A) including polyether ether ketone as a continuous phase; and
a resin (B) with a relative dielectric constant of 2.6 or less as a dispersed phase.

2. The insulated wire according to claim 1, wherein parts by mass ratio of the resin (A) to the resin (B) “(A)/(B)” is from 25/70 to 60/35.

3. The insulated wire according to claim 1, wherein:
the resin (A) is polyether ether ketone or a mixture of polyether ether ketone and polyphenylene sulfide, and
the resin (B) is polyethylene, polypropylene, 4-methylpentene-1, syndiotactic polystyrene or a mixture of two or more thereof.

4. The insulated wire according to claim 2, wherein:
the resin (A) is polyether ether ketone or a mixture of polyether ether ketone and polyphenylene sulfide, and
the resin (B) is polyethylene, polypropylene, 4-methylpentene-1, syndiotactic polystyrene or a mixture of two or more thereof.

5. The insulated wire according to claim 1, wherein the resin (A) has an apparent viscosity at 380° C. less than the apparent viscosity at 380° C. of the resin (B).

6. The insulated wire according to claim 2, wherein the resin (A) has an apparent viscosity at 380° C. less than the apparent viscosity at 380° C. of the resin (B).

7. The insulated wire according to claim 3, wherein the resin (A) has an apparent viscosity at 380° C. less than the apparent viscosity at 380° C. of the resin (B).

8. The insulated wire according to claim 4, wherein the resin (A) has an apparent viscosity at 380° C. less than the apparent viscosity at 380° C. of the resin (B).

9. The insulated wire according to claim 5, wherein the apparent viscosity of the resin (A) at 380° C. is 2000 Pa·s or less.

10. The insulated wire according to claim 6, wherein the apparent viscosity of the resin (A) at 380° C. is 2000 Pa·s or less.

11. The insulated wire according to claim 7, wherein the apparent viscosity of the resin (A) at 380° C. is 2000 Pa·s or less.

12. The insulated wire according to claim 8, wherein the apparent viscosity of the resin (A) at 380° C. is 2000 Pa·s or less.

13. The insulated wire according to claim 1, wherein at least one additional coating layer made of one of thermoplastic polyamide-imide, thermoplastic polyimide, polyetherimide and polyphenylene sulfide is further formed on the at least one extruded insulation layer.

14. The insulated wire according to claim 2, wherein at least one additional coating layer made of one of thermoplastic polyamide-imide, thermoplastic polyimide, polyetherimide and polyphenylene sulfide is further formed on the at least one extruded insulation layer.

15. The insulated wire according to claim 3, wherein at least one additional coating layer made of one of thermoplastic polyamide-imide, thermoplastic polyimide, polyetherimide and polyphenylene sulfide is further formed on the at least one extruded insulation layer.

16. The insulated wire according to claim 4, wherein at least one additional coating layer made of one of thermoplastic polyamide-imide, thermoplastic polyimide, polyetherimide and polyphenylene sulfide is further formed on the at least one extruded insulation layer.
